(19) United States
(12) Patent Application Publication
(10) Pub. No.: US 2016/0160765 A1
(43) Pub. Date: Jun. 9, 2016

(54) EXHAUST SYSTEM AND ENGINE PROVIDED WITH THE SAME

(71) Applicant: HYUNDAI MOTOR COMPANY, Seoul (KR)

(72) Inventors: Hong Kil BAEK, Seoul (KR); Seung Woo LEE, Seoul (KR); Tae Won LEE, Incheon (KR)

(21) Appl. No.: 14/829,569

(22) Filed: Aug. 18, 2015

(30) Foreign Application Priority Data
Dec. 9, 2014 (KR) 10-2014-0175834

(51) Int. Cl. F02D 13/02; F01N 11/00; F01N 13/10; F01N 3/10

(52) U.S. Cl. CPC F02D 13/0246; F01N 3/10; F01N 11/002; F01N 13/107; F01N 2550/02

(57) ABSTRACT

An exhaust system comprises a first exhaust manifold connected to a first exhaust port of a cylinder; a second exhaust manifold connected to a second exhaust port of the cylinder; a variable valve lift apparatus controlling a valve that closes and opens the first exhaust port; an after-treatment apparatus connected to the first exhaust manifold and the second exhaust manifold; an exhaust temperature sensor; and a controller controlling the variable valve lift apparatus based on an output signal of the exhaust temperature sensor.

### CROSS-REFERENCE TO RELATED APPLICATION

This application claims the benefit of priority to Korean Patent Application No. 10-2014-0175834, filed in the Korean Intellectual Property Office on Dec. 9, 2014, the entire content of which is incorporated herein by reference.

### TECHNICAL FIELD

The present disclosure relates to an exhaust system and an engine provided with the same. More particularly, the present disclosure relates to an exhaust system and an engine provided with the same which may reduce noxious gas.

### BACKGROUND

Due to increased environmental problems, vehicle exhaust gas regulations have been strengthening.

Vehicular industries have researched developing an exhaust system that reduces harmful elements in exhaust gas, to reduce unburned gas and to improve fuel consumption.

For reducing noxious gas, after-treatment devices, including a DPF (Diesel Particulate Filter) for reducing PM (particle material) and NOx (nitrogen oxide), a DOC (Diesel Oxidation Catalyst), and an SCR (Selective Catalyst Reduction) for purifying exhaust gas, have been applied to an exhaust system.

The after-treatment devices use metal material such as platinum, palladium and so on as catalysts, and for activating the catalysts, the temperature of the exhaust gas needs to be raised.

For that purpose, time and additional fuel are required, or an electric heater is needed to raise the temperature of the catalysts. However, those methods may deteriorate a vehicle's fuel consumption.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to provide an exhaust system and an engine provided with the same which may reduce an activating time of a catalyst in an after-treatment apparatus so as to reduce noxious gas without additional energy consumption.

An exhaust system according to one exemplary embodiments of the present inventive concept may include a first exhaust manifold connected to a first exhaust port of a cylinder; a second exhaust manifold connected to a second exhaust port of the cylinder; a variable valve lift apparatus controlling a valve that closes and opens the first exhaust port; an after-treatment apparatus connected to the first exhaust manifold and the second exhaust manifold; an exhaust temperature sensor; and a controller controlling the variable valve lift apparatus based on an output signal of the exhaust temperature sensor.

The controller may control the variable valve lift apparatus in a normal operation state when a temperature of an exhaust gas is higher than a predetermined reference temperature.

An operation mode of the variable valve lift apparatus may comprise a normal mode and a CDA operation mode.

The after-treatment apparatus may comprises a catalyst; and the predetermined reference temperature may be based on an activating temperature of the catalyst.

The controller may control the variable valve lift apparatus in a deactivated state when an engine starts; and the controller may control the variable valve lift apparatus in a normal operation state when a temperature of an exhaust gas is higher than a predetermined reference temperature.

An operation mode of the variable valve lift apparatus may comprise a normal mode and a CDA operation mode.

The after-treatment apparatus may comprises a catalyst; and the predetermined reference temperature may be based on an activating temperature of the catalyst.

An engine may comprise a first exhaust manifold connected to a first exhaust port of a cylinder of the engine; a second exhaust manifold connected to a second exhaust port of the cylinder of the engine; a variable valve lift apparatus controlling a valve that closes and opens the first exhaust port; an after-treatment apparatus connected to the first exhaust manifold and the second exhaust manifold; an exhaust temperature sensor; and a controller controlling an operation of the variable valve lift apparatus based on an output signal of the exhaust temperature sensor.

An operation mode of the variable valve lift apparatus may comprise a normal mode and a CDA operation mode.

The controller may control the variable valve lift apparatus in the normal mode when a temperature of an exhaust gas is higher than a predetermined reference temperature.

The after-treatment apparatus may comprises a catalyst; and the predetermined reference temperature may be based on an activating temperature of the catalyst.

The controller may control the variable valve lift apparatus in the CDA operation mode when the engine starts; and the controller may control the variable valve lift apparatus in the normal mode when a temperature of an exhaust gas is higher than a predetermined reference temperature.

The after-treatment apparatus may comprise a catalyst; and the predetermined reference temperature may be based on an activating temperature of the catalyst.

### BRIEF DESCRIPTION OF THE DRAWINGS

FIG. 1 show an engine provided with an exhaust system according to according to one or a plurality of exemplary embodiments of the present inventive concept.

FIG. 2 and FIG. 3 show operations of an engine provided with an exhaust system according to according to one or a plurality of exemplary embodiments of the present inventive concept.

FIGS. 4A and 4B show graphs of profiles in each operation mode of valves applied to an exhaust system according to according to one or a plurality of exemplary embodiments of the present inventive concept.

### DETAILED DESCRIPTION

In the following detailed description, only certain exemplary embodiments of the present inventive concept have been shown and described, simply by way of illustration.

As those skilled in the art would realize, the described embodiments may be modified in various different ways, all without departing from the spirit or scope of the present inventive concept.

A part irrelevant to the description will be omitted to clearly describe the present inventive concept, and the same or similar elements will be designated by the same reference numerals throughout the specification.

In the drawings, the thickness of layers, films, panels, regions, etc., are exaggerated for clarity.

Throughout the specification and the claims, unless explicitly described to the contrary, the word “comprise” and variations such as “comprises” or “comprising”, will be understood to imply the inclusion of stated elements but not the exclusion of any other elements.

An exemplary embodiment of the present inventive concept will hereinafter be described in detail with reference to the accompanying drawings.

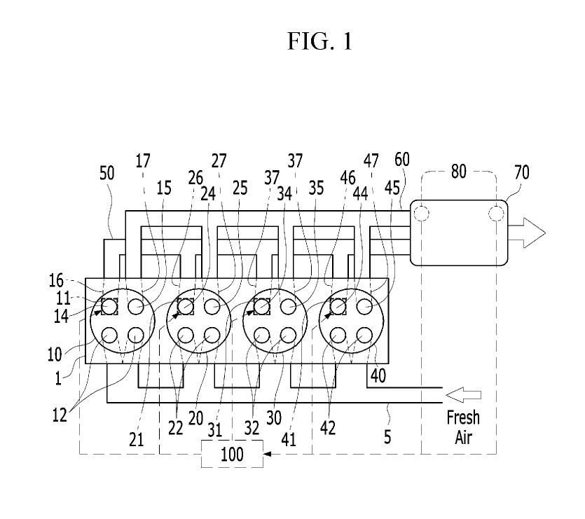

FIG. 1 show an engine provided with an exhaust system according to one exemplary embodiment of the present inventive concept.

Referring to FIG. 1, in a specification and claims, an engine is defined to include an intake manifold 5, an engine body 1, an exhaust manifold and an after-treatment apparatus and so on.

In the engine body 1, a plurality of cylinder, for example as shown in the drawings, 4 cylinders 10, 20, 30 and 40 are formed, and intake valves 12, 22, 32 and 42 are disposed to the each cylinder 10, 20, 30 and 40 for supplying fresh air or air-fuel mixture supplied through the intake manifold 5 into the each cylinders 10, 20, 30 and 40 by closing and opening.

The each cylinder 10, 20, 30 and 40 is connected with first exhaust ports 16, 26, 36 and 46 and second exhaust ports 17, 27, 37 and 47 respectively.

First exhaust valves 14, 24, 34 and 44 are disposed for closing and opening the first exhaust ports 16, 26, 36 and 46 respectively, and second exhaust valves 15, 25, 35 and 45 are disposed for closing and opening the second exhaust ports 17, 27, 37 and 47 respectively.

The exhaust system according to one exemplary embodiment of the present inventive concept includes a first exhaust manifold 50 connected to the first exhaust ports 16, 26, 36 and 46 of the cylinders 10, 20, 30 and 40 respectively, a second exhaust manifold 60 connected to second exhaust ports 17, 27, 37 and 47 of the cylinders 10, 20, 30 and 40 respectively, variable valve lift apparatuses 11, 21, 31 and 41 selectively controlling lifts of the valves 14, 24, 34 and 44 closing and opening the first exhaust ports 16, 26, 36 and 46 respectively, an after-treatment apparatus 70 connected to the first exhaust manifold 50 and the second exhaust manifold 60, an exhaust temperature sensor 80 disposed with the after-treatment apparatus 70 and a controller 100 controlling operations of the variable valve lift apparatuses 11, 21, 31 and 41 according to an output signal of the exhaust temperature sensor 80.

The after-treatment apparatus 70 may be, for example, a DPF (Diesel Particulate Filter) for reducing PM (particle material) and NOx (nitrogen oxide), a DOC (Diesel Oxidation Catalyst), an SCR (Selective Catalyst Reduction), or another after-treatment apparatus.

The exhaust temperature sensor 80 may be disposed as a pair both upstream and downstream of the after-treatment apparatus 70 for sensing temperatures of flowed exhaust gas and after-treated exhaust gas, or the exhaust temperature sensor 80 may be disposed solely upstream or downstream of the after-treatment apparatus 70.

The controller 100 controls the variable valve lift apparatuses 11, 21, 31 and 41 in a normal operation state when the temperature of the exhaust gas sensed by the exhaust temperature sensor 80 is higher than a predetermined reference temperature.

The controller 100 controls the variable valve lift apparatuses 11, 21, 31 and 41 in a deactivated state when the engine starts and the controller 100 controls the variable valve lift apparatuses 11, 21, 31 and 41 in a normal operation state when the temperature of the exhaust gas sensed by the exhaust temperature sensor 80 is higher than a predetermined reference temperature.

The after-treatment apparatus 70 includes a catalyst and the predetermined reference temperature is determined in accordance with an activating temperature of the catalyst. The catalyst may be a material such as platinum, palladium and so on, and, for activating the catalysts, the temperature of the exhaust gas may need to be raised.

Operation modes of the variable valve lift apparatuses 11, 21, 31 and 41 include a normal mode and a CDA operation mode.

In the CDA operation mode, the controller 100 deactivates the variable valve lift apparatuses 11, 21, 31 and 41, and opens and closes the variable valve lift apparatuses 11, 21, 31 and 41 in the normal mode.

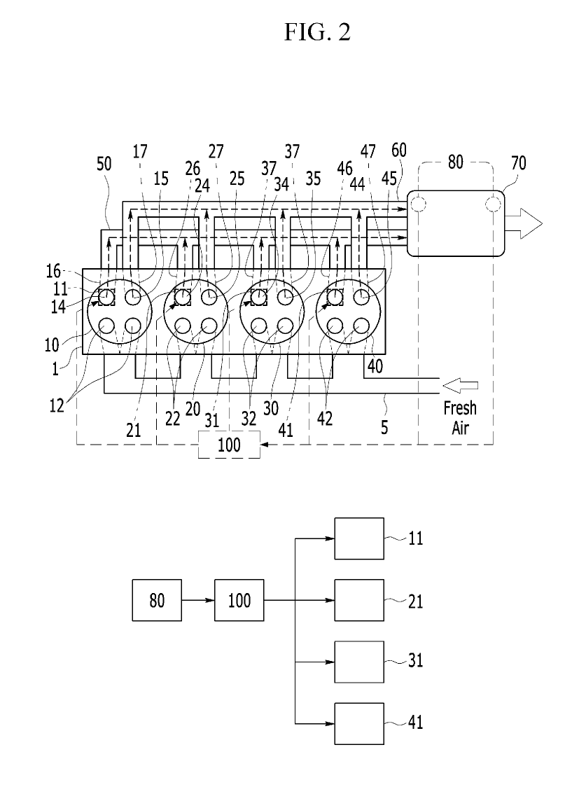

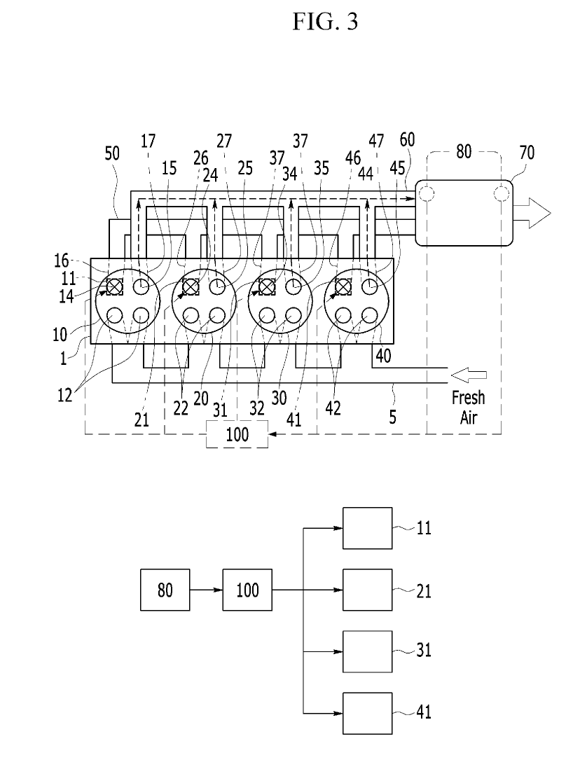

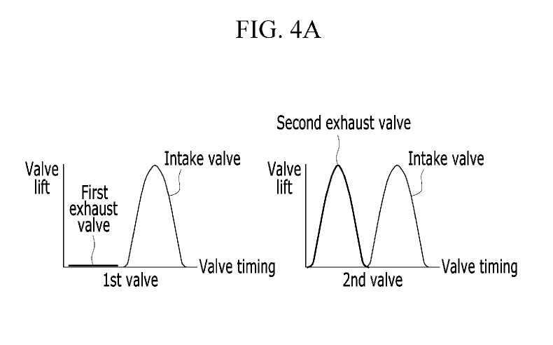

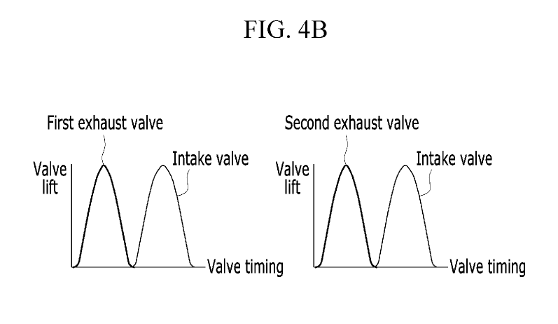

FIG. 2 and FIG. 3 show operations of an engine provided with an exhaust system according to one exemplary embodiment of the present inventive concept, and FIG. 4 shows graphs of profiles in each operation mode of valves applied to an exhaust system according to one exemplary embodiment of the present inventive concept.

Hereinafter, operations of the exhaust system according to one exemplary embodiment of the present inventive concept will be described referring to drawings.

As shown in FIG. 4A, before the catalyst reaches an activating temperature, such as when the engine is starting, the controller 100 controls the variable valve lift apparatuses 11, 21, 31 and 41 to be deactivated, that is, in the CDA mode.

Then the exhaust gas exhausted from the cylinders 10, 20, 30 and 40 is supplied to the after-treatment apparatus 70 through the second exhaust ports 17, 27, 37 and 47 and the second exhaust manifold 60.

Since the exhaust gas flows only through the second exhaust manifold 60, relative heat capacity of the exhaust system is reduced.

Thus, temperature of the exhaust gas is relatively high, and the time of activating the catalyst may be reduced.

And then, if the temperature sensed by the exhaust temperature sensor 80 is higher than the predetermined reference temperature determined in accordance with the activating temperature of the catalyst, the controller 100, as shown in FIG. 4B, controls the variable valve lift apparatuses 11, 21, 31 and 41 to be normally opened and closed for the exhaust gas to be flowed through the first and the second exhaust manifolds 50 and 60. Thus, passages for the exhaust gas to be flowed are relatively widened and deterioration of exhaust performance may be prevented.

The exhaust system and the engine provided with the same according to one exemplary embodiment of the present inventive concept may reduce an activating time of a catalyst in an after-treatment apparatus so as to reduce noxious gas.

While this inventive concept has been described in connection with what is presently considered to be practical exemplary embodiments, it is to be understood that the inventive concept is not limited to the disclosed embodiments. On the contrary, it is intended to cover various modifications and equivalent arrangements included within the spirit and scope of the appended claims.

What is claimed is:

1. An exhaust system comprising:
a first exhaust manifold connected to a first exhaust port of a cylinder;
a second exhaust manifold connected to a second exhaust port of the cylinder;
a variable valve lift apparatus controlling a valve that closes and opens the first exhaust port;
an after-treatment apparatus connected to the first exhaust manifold and the second exhaust manifold;
an exhaust temperature sensor; and
a controller controlling the variable valve lift apparatus based on an output signal of the exhaust temperature sensor.

2. The exhaust system of claim 1, wherein the controller controls the variable valve lift apparatus in a normal operation state when a temperature of an exhaust gas is higher than a predetermined reference temperature.

3. The exhaust system of claim 2, wherein an operation mode of the variable valve lift apparatus comprises a normal mode and a CDA operation mode.

4. The exhaust system of claim 2, wherein:
the after-treatment apparatus comprises a catalyst; and
the predetermined reference temperature is based on an activating temperature of the catalyst.

5. The exhaust system of claim 1, wherein:
the controller controls the variable valve lift apparatus in a deactivated state when an engine starts; and
the controller controls the variable valve lift apparatus in a normal operation state when a temperature of an exhaust gas is higher than a predetermined reference temperature.

6. The exhaust system of claim 5, wherein an operation mode of the variable valve lift apparatus comprises a normal mode and a CDA operation mode.

7. The exhaust system of claim 5, wherein:
the after-treatment apparatus comprises a catalyst; and
the predetermined reference temperature is based on an activating temperature of the catalyst.

8. An engine comprising:
a first exhaust manifold connected to a first exhaust port of a cylinder of the engine;
a second exhaust manifold connected to a second exhaust port of the cylinder of the engine;
a variable valve lift apparatus controlling a valve that closes and opens the first exhaust port;
an after-treatment apparatus connected to the first exhaust manifold and the second exhaust manifold;
an exhaust temperature sensor; and
a controller controlling an operation of the variable valve lift apparatus based on an output signal of the exhaust temperature sensor.

9. The engine of claim 8, wherein an operation mode of the variable valve lift apparatus comprises a normal mode and a CDA operation mode.

10. The engine of claim 9, wherein the controller controls the variable valve lift apparatus in the normal mode when a temperature of an exhaust gas is higher than a predetermined reference temperature.

11. The engine of claim 10, wherein:
the after-treatment apparatus comprises a catalyst; and
the predetermined reference temperature is based on an activating temperature of the catalyst.

12. The engine of claim 9, wherein:
the controller controls the variable valve lift apparatus in the CDA operation mode when the engine starts; and
the controller controls the variable valve lift apparatus in the normal mode when a temperature of an exhaust gas is higher than a predetermined reference temperature.

13. The engine of claim 12, wherein:
the after-treatment apparatus comprises a catalyst; and
the predetermined reference temperature is based on an activating temperature of the catalyst.
